(19) United States
(12) Patent Application Publication
(10) Pub. No.: US 2016/0011415 A1
(43) Pub. Date: Jan. 14, 2016

(54) OPTICAL LENS, METHOD FOR PRODUCING SAME, LENS UNIT, IMAGE-CAPTURING MODULE, AND ELECTRONIC DEVICE

(71) Applicant: FUJIFILM CORPORATION, TOKYO (JP)

(72) Inventor: GOROH TAKADA, SAITAMA (JP)

(21) Appl. No.: 14/835,629

(22) Filed: Aug. 25, 2015

Related U.S. Application Data
(63) Continuation of application No. PCT/JP2014/057650, filed on Mar. 20, 2014.

(30) Foreign Application Priority Data
Mar. 26, 2013 (JP) 2013-064110
Mar. 3, 2014 (JP) 2014-040559

(51) Int. Cl. G02B 27/00; G02B 1/12; G02B 1/111; G02B 13/00; H04N 5/225

(52) U.S. Cl. CPC G02B 27/0018; G02B 13/001; H04N 5/225; G02B 1/111; G02B 1/12

(57) ABSTRACT

An optical lens includes a lens section that transmits light therethrough; and a light shielding section provided close to the lens section, the light shielding section having a light shielding film formed on a surface of a lens base material. The surface layer of at least a part of the light shielding film including an inner edge thereof on a lens section side, and a boundary portion of the lens section in contact with the light shielding layer is subjected to a roughening process.

### CROSS-REFERENCE TO RELATED APPLICATIONS

This application is a Continuation of PCT International Application No. PCT/JP2014/057650 filed on Mar. 20, 2014, which claims priority under 35 U.S.C §119(a) to Japanese Patent Application No. 2013-064110 filed on Mar. 26, 2013 and Japanese Patent Application No. 2014-040559 filed on Mar. 3, 2014. Each of the above applications is hereby expressly incorporated by reference, in its entirety, into the present application.

### BACKGROUND OF THE INVENTION

1. Field of the Invention

The present invention relates to an optical lens, a method for producing the same, a lens unit, an imaging module, and an electronic device.

2. Description of the Related Art

Imaging modules, which are built into and used in electronic devices such as digital cameras and mobile phones, have improved in image quality of a photographic image by removing unnecessary incident light so as to prevent flares and ghosts from occurring. As measures for image quality, for example, the following configurations have been proposed: a configuration in which a ring-shaped light shielding sheet is provided around a lens section used in an imaging module so as to block unnecessary light; a configuration in which a light shielding film is directly formed on a lens surface (refer to JP2012-208391A, JP2009-175331A, and JP2008-185772A); and the like.

### SUMMARY OF THE INVENTION

However, even if the light shielding sheet is provided around the lens section, stray light occurs, and thus flares and ghosts cannot be perfectly prevented from occurring. It is necessary for the light shielding sheet to have a certain thickness in terms of the light shielding property, a handling property in assembly, a mechanical strength, and the like. Hence, a thickness of a side surface of the light shielding sheet close to the inner edge thereof increases, and incident light, which is reflected from the side surface close to the inner edge, enters into a lens, whereby stray light occurs.

Further, even when the light shielding film is directly formed on the lens surface, stray light occurs. The reason for this occurrence is that incident light is reflected from the light shielding film surface after the light shielding film is formed through printing or coating and the reflected light becomes stray light.

As described above, even when the light shielding sheet is disposed, or even when the light shielding film is formed on the lens surface, in practice, the effect caused by outside light or internal reflected light in the lens cannot be perfectly eliminated. Hence, there has been a demand for a technique of more reliably removing unnecessary light in the optical lens.

The present invention has been made in view of the above-mentioned situation to provide an optical lens, a method for producing the same, a lens unit, an imaging module, and an electronic device capable of preventing stray light from occurring by restricting surface reflection on the light shielding film.

The present invention adopts the following configurations.

(1) An optical lens including: a lens section that transmits light; and a light shielding section provided close to the lens section, in which the light shielding section has a light shielding film formed on a surface of a lens base material, and in which a surface layer of at least a part of the light shielding film including an inner edge thereof on a lens section side, and a boundary portion of the lens section in contact with the light shielding layer is subjected to a roughening process.

(2) A lens unit, in which at least one optical lens as above is disposed.

(3) An imaging module including: the lens unit; and an imaging device that detects an image which is formed by the lens unit.

(4) An electronic device, including the imaging module mounted therewith.

(5) A method for producing an optical lens including a lens section that transmits light and a light shielding section provided close to the lens section, the method including: forming a light shielding film on at least a part of the light shielding section; and performing a roughening process in a range extending from an inner edge of a surface layer of the light shielding film on a lens section side toward an optical axis of the lens section.

According to the present invention, stray light is prevented from occurring by restricting surface reflection on the light shielding film of the optical lens, and unnecessary light is reliably eliminated.

### BRIEF DESCRIPTION OF THE DRAWINGS

FIG. 1 is a schematic sectional view of an imaging module according to an embodiment of the present invention.

FIG. 2 is a partially enlarged sectional view illustrating a section including a lens optical axis of an optical lens.

FIG. 3 is a schematic sectional view of a light shielding section.

FIGS. 4A, 4B, and 4C are explanatory diagrams illustrating a situation where a light shielding film is formed and a roughening process is performed thereon.

FIG. 5 is an explanatory diagram illustrating effects of a light shielding film itself and a roughened region of the light shielding film.

FIG. 6 is a partially enlarged sectional view of the optical lens in which a light shielding layer is constituted of a plurality of layers.

FIGS. 7A, 7B, and 7C are plan views illustrating various planar shapes of the light shielding film.

### DESCRIPTION OF THE PREFERRED EMBODIMENTS

Hereinafter, embodiments of the present invention will be described with reference to drawings.

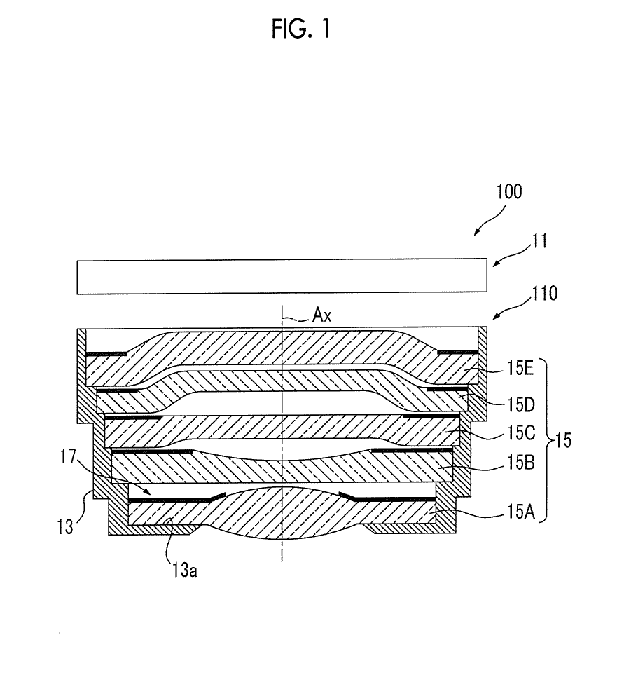

FIG. 1 is a schematic sectional view of an imaging module according to an embodiment of the present invention.

The imaging module 100 has a lens unit 110 and an imaging section 11 that includes an imaging device, and is disposed in a casing of an electronic device such as a digital camera supported by a supporting member such as a substrate which is not shown in the figure.

The lens unit 110 has at least one optical lens 15 which is disposed to overlap in a direction of a lens optical axis Ax inside a lens holder 13. The plurality of optical lenses 15, which are fixed onto the lens holder 13, concentrates light onto the imaging section 11 on the upper side of the drawing from a subject side on the lower side of the drawing, and forms an optical image of a subject on a light receiving surface of the imaging device of the imaging section 11.

FIG. 1 shows examples of five optical lenses 15A, 15B, 15C, 15D, and 15E. The number of lenses is not limited to this example. Further, the optical lenses 15A, 15B, 15C, 15D, and 15E may be configured to be respectively supported by a plurality of lens holders which are individually provided, and may be configured as a zoom lens mechanism, an auto focus mechanism, and an image stabilizer mechanism in which a specific optical lens is supported to be movable in an optical axis direction.

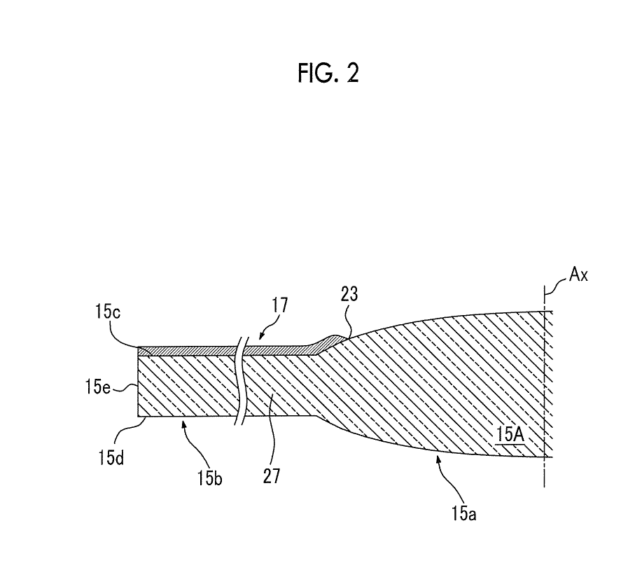

FIG. 2 is a partially enlarged sectional view illustrating a section including a lens optical axis Ax of an optical lens 15A. The optical lens 15A has a lens section 15a that transmits light; and a light shielding section 15b that is provided close to the lens section 15a. The light shielding section 15b includes a light shielding film 17 that has a region in which a roughening process is performed on at least a part of a surface layer.

As a material of the optical lens 15A (it is also the same for the lenses 15B to 15E), a transparent resin material having a high light transmittance, shape stability, and excellent workability is suitably used. Examples of the materials include cyclic olefin copolymer (COC), cycloolefin polymer (COP), polycarbonate (PC), and the like.

The light shielding section 15b is provided outside the lens section 15a, and is configured to include the light shielding film 17 that restricts rays transmitted onto at least any one surface of a light incidence side surface 15d and a light exit side surface 15c of surfaces of a lens base material 27 in the light shielding section 15b. In the example shown in the drawing, the light shielding film 17 is formed on the light exit side surface 15c.

The optical lens 15A is supported by the lens holder 13 so as to be in contact with a stepped portion 13a (refer to FIG. 1) in which the light incidence side surface 15d of the surfaces of the lens base material 27 is foamed inside the lens holder 13.

The light shielding film 17, which is formed on the light exit side surface 15c of the surfaces of the lens base material 27, is a film which is formed along the outer circumference of the lens section 15a with a predetermined width in a lens-radial direction, and is formed on at least an exposed surface of the optical lens 15A. The exposed surface described herein means a region where the light shielding film 17 is exposed to the outside (air) except for a region where the light shielding film 17 is in direct contact with or is covered by other members.

The light shielding film 17 may be configured not only to be provided in front of the light exit side surface 15c of the surfaces of the lens base material 27 as described above. The light shielding film 17 may also be configured to be provided on at least the inner edge side of the light exit side surface 15c. Further, the light shielding film 17 may be configured to be provided on only the light incidence side surface 15d, to be provided on both surfaces 15c and 15d, and to be provided on both surfaces 15c and 15d and a side surface 15e. An antireflection process such as anti-reflection coating (AR coating) may be applied to the surface of the lens section 15a of the optical lens 15A.

The light shielding film 17 can be formed in various methods of printing, coating, stamping, and the like of ink including a material, such as a black pigment or a black dye, with a light shielding property. Among the methods, it is preferable to use an ink jet method by which it is possible to obtain high dimension accuracy. Further, as the roughening process, a physical process such as a blasting process or a chemical process such as etching can be used. Among the processes, it is preferable to use a laser blasting process in which a light diffusion property can be adjusted without restriction and intensity of the laser can be simply adjusted.

When the laser blasting process is performed, it is preferable to use, as the laser, a high-peak pulse generating laser such as a Q switch laser of which the center wavelength is equal to or less than 1100 nm.

As the material with the light shielding property included in the light shielding film 17, it is possible to use various known black pigments and black dyes. As the black material, it is preferable to use carbon black, titanium black, iron oxide, manganese oxide, and graphite which is capable of achieving a high optical density with a small amount. Further, a black material formed by mixing a red material, a green material, and a blue material may be used.

As the ink used in the ink jet method, it is possible to use, for example, an ink jet ink which contains 80 to 90% of a photosensitive monomer, 10 to 20% of an initiator, and 1 to 5% of carbon black.

Further, it is preferable that the light shielding film 17 has a refractive index approximate to a refractive index of the lens material in terms of reducing reflection inside the lens. As the ink density becomes more uniform, the effect of reduction in reflection becomes stronger.

The roughening process is performed on the entire exposed surface of the light shielding film 17. The roughening process is performed on a surface layer on at least a part of the exposed surface of the light shielding film 17 including an inner edge 23 thereof on the lens section 15a side as well as a boundary portion of the lens section 15a in contact with the light shielding film. That is, the roughening process is performed in a range extending beyond the inner edge 23 of the light shielding film 17 on the lens section 15a side toward the lens optical axis Ax of the lens section 15a.

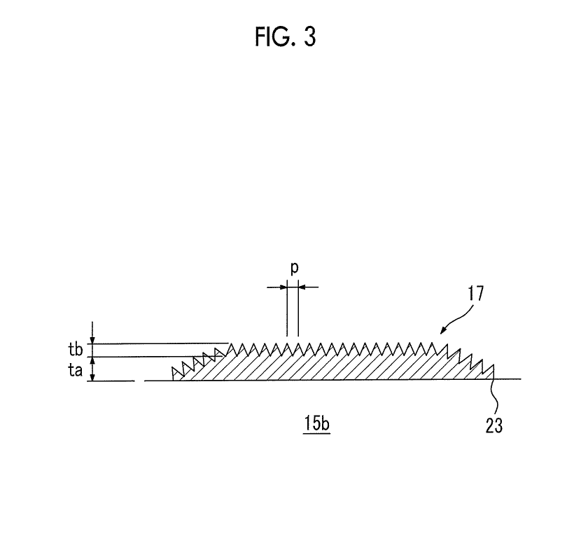

FIG. 3 shows a schematic sectional view of the light shielding film 17. The surface of the surface layer of the light shielding film 17 is roughened with fine irregularities through the roughening process. A depth tb of the fine irregularities of this roughened surface is equal to or greater than 1 μm and equal to or less than 5 p.m. Further, a film thickness ta of the light shielding film 17, which remains after the roughening process, is within a range of 10 to 40 μm, and more preferably within a range of 20 to 30 μm. By setting the film thickness ta of the light shielding film 17 subjected to the roughening process in the above-mentioned range, it is possible to obtain the light shielding property necessary and sufficient in a range where productivity is not lowered, and thus a property of adhesion to the optical lens 15A is also satisfactorily maintained.

Regarding a relationship between the depth tb and an average pitch p of the fine irregularities formed through the roughening process, a value of (tb/p) is equal to or greater than 0.1, and the value is more preferably greater than 1. By setting the value in this range, reflection from the surface of the region, in which the roughening process is performed, is restricted to a level at which the reflection has no effect on image quality of an image captured by the imaging module 100. When the average pitch of the fine irregularities becomes extremely large or extremely small, the surface reflection tends to increase. However, the light scattering effect becomes stronger within the above-mentioned range.

The surface roughness of the region, in which the roughening process is performed, is suitably set on the basis of an optical design. However, in terms of an RMS value, it is preferable that a value of the surface roughness is equal to or less than a value of equal to or greater than 0.1 and equal to or less than 5 μm (measuring instrument: Form Talysurf (manufactured by Taylor Hobson Ltd.)).

Next, processes of forming and roughening the light shielding film 17 will be described.

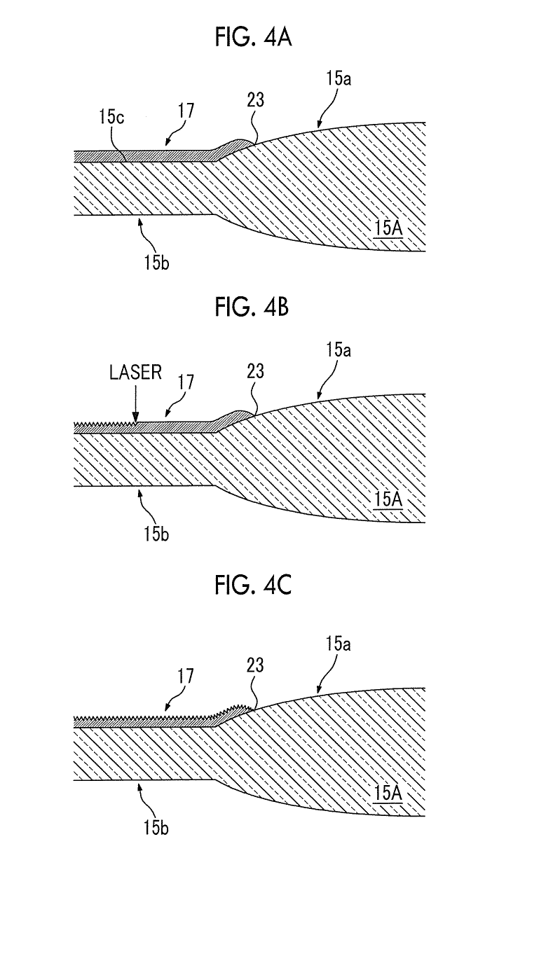

FIGS. 4A, 4B, and 4C are explanatory diagrams illustrating a situation where the light shielding film 17 is formed and the roughening process is performed thereon. First, as shown in FIG. 4A, the light shielding film 17 is formed on the light exit side surface 15c of the light shielding section 15b of the optical lens 15A through the ink jet method. Next, as shown in FIGS. 4B and 4C, the light shielding film 17 is roughened with fine irregularities through a laser blasting process in which the exposed surface of the formed light shielding film 17 is scanned with laser light.

In the laser blasting process, it is preferable that only the range in which the light shielding film 17 is formed is irradiated with laser light. However, it is difficult to positionally adjust the range, which is irradiated by the laser light, to the inner edge 23 of the light shielding film 17 which is not subjected to the blasting process, with high accuracy. That is, when the inner edge 23 of the light shielding film 17 as a target position is subjected to the blasting process, due to a process error, the blasting process may not reach the inner edge 23 of the light shielding film 17, and a part of the edge portion of the light shielding film 17 may not be subjected to the blasting process. In this case, the remaining part of the inner edge 23 of the light shielding film 17, which is not subjected to the blasting process, is formed as a reflective surface. The reflected light from the reflective surface becomes stray light, and causes flares and ghosts.

Accordingly, by performing the blasting process in a range from the inner edge 23 of the light shielding film 17 to a position over the lens section 15a side (lens optical axis Ax side), it is possible to reliably perform the roughening process on the surface layer of the light shielding film including the inner edge 23 of the light shielding film 17. In the range of the blasting process from the inner edge 23 of the light shielding film 17 to the lens section 15a side, the surface of the lens section 15a is roughened. However, even when a part of the surface of the lens section 15a is roughened to have the light diffusion property, a light amount of the transmitted rays is less lowered. Hence, this lowering has no great effect on an optical image of a subject.

Further, as shown in FIG. 4A, it is preferable that a thickness of the light shielding film 17, which is has not been subjected to the blasting process, is formed to decrease from the light shielding section 15b to the lens section 15a. By inclining the thickness of the light shielding film 17, when the optical lens 15A is viewed from the lens optical axis Ax, no portion of the shielding film is hidden. As a result, the laser light is not blocked. Hence, it becomes easy for the roughening process to be performed on the entire exposed portion of the light shielding film 17.

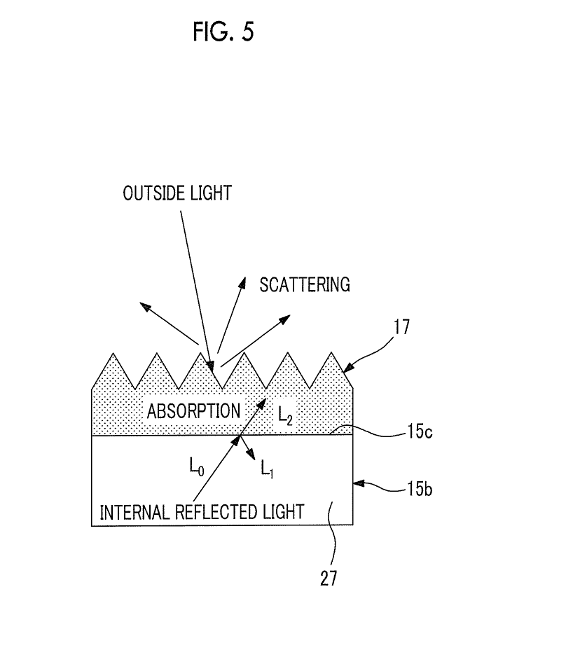

FIG. 5 is an explanatory diagram illustrating effects of a light shielding film 17 itself and a roughened region of the light shielding film. The roughened region of the light shielding film 17 is able to prevent the outside light from being regularly reflected from or entering into the lens through light absorption of the light shielding film 17 itself and light diffusion caused by the fine irregularities of the roughened surface layer.

Light L₀, which is internally reflected in the lens, is separated into reflected light L₁, which returns back to the lens, and absorbed light L₂, which is absorbed by the light shielding film 17, at the interface between the light shielding film 17 and the light exit side surface 15c of the surfaces of the lens base material 27. Since a material of the light shielding film 17 has a refractive index approximate to that of the lens, a reflectance of the interface between the light shielding film 17 and the light exit side surface 15c of the surfaces of the lens base material 27 is small. Hence, an intensity of the reflected light L₁ is weak. Accordingly, the reflected light L₁ originating from the light L₀, which is internally reflected in the lens, can be weakened due to the separated absorbed light L₂, and thus an intensity of the reflected light L₁ itself can be weakened. Further, the interface between the light shielding film 17 and the exit side surface 15c of the surfaces of the lens base material 27 has high flatness, and the ink density thereof is kept constant. Therefore, with such a configuration, scattering of light, which returns back into the lens, is restricted.

The roughening process of the light shielding film 17 may be sand blasting instead of the laser blasting process. The laser blasting process is preferable as the roughening process because a pre-process such as providing a mask on the processing target surface is not necessary, and therefore the roughening process can be simplified. Further, since a laser spot size is changeable, the process, which is uniformly performed on a wide area with laser light having a large spot size, or the process, which is accurately performed in a small region with laser light having a small spot size, is easily performed at an arbitrary position. Furthermore, the surface roughness is changeable in accordance with a laser drawing pattern or adjustment in intensity of the laser output. Thus, the surface roughness can be changed in accordance with a desired degree of roughening.

Further, optical lenses may overlap with each other such that the light shielding film 17 of the optical lens 15 is in direct contact with a part of another optical lens, or the lens may be fixed with the light shielding film 17 interposed therebetween such that the lens is in contact with the stepped portion 13a of the lens holder 13 (refer to FIG. 1). In this case, the laser blasting process can be used in adjusting intervals between the lenses or adjusting support postures of the lenses by changing the thickness of the light shielding film 17 through adjustment in intensity of the laser output.

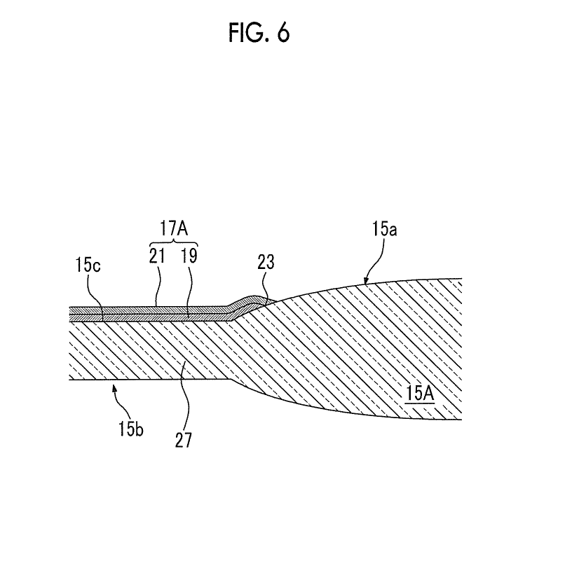

Furthermore, it is more preferable that the light shielding section 15b is formed of a plurality of layers separately formed. FIG. 6 shows a partially enlarged sectional view of the optical lens in which a light shielding layer is constituted of a plurality of layers.

In this case, the light shielding film 17A is a multilayer film which is formed on the light exit side surface 15c of the surfaces of the lens base material 27 of the optical lens 15A, and has a light shielding layer 19 that restricts transmitted rays and a roughened layer 21 that is formed on the light shielding layer 19. The light shielding layer 19 may employ a material the same as that of the above-mentioned light shielding film 17. The roughened layer 21 may be a light diffusion layer. The layer is formed through printing, coating, or the like, and is thereafter roughened by forming fine irregularities on a surface of the layer. The roughening process performed on the roughened layer 21 is not limited to a laser blasting method, and may be another known roughening process such as a sand blasting method.

By using the light shielding film 17A having a multi layered structure in the light shielding section 15b, a material having excellent light absorption can be selected for the light shielding layer 19, and a material suitable for the roughening process such as the laser blasting process can be selected for the roughened layer 21. Hence, a degree of freedom in material selection is higher, and thus it is possible to use a material with a strong light shielding property, a material with a low surface reflectivity, or the like. As a result, it is possible to improve a degree of freedom in design.

In the optical lens 15 having the present configuration, the light shielding film 17 is formed by an ink jet method. By forming the light shielding film 17 by an ink jet method, it is possible to easily change a region in which the ink is applied. Hence, various kinds of optical lens can be produced at low cost. Further, when using an ultraviolet curable UV ink, it is possible to immediately cure the ink through ultraviolet irradiation after landing the ink, without heat treatment. Hence, in plastic lenses which are less resistant to heat, accuracy in ink landing position, that is, accuracy in edge position of the inner edge of the light shielding film 17 is obtained.

In the ink jet method, the amount of the ink ejected from an ink ejection head per a single ejection is set to be equal to or greater than 0.1 am³ and be equal to or less than 10 fm³. In this case, ink flow or ink splashing at the ink landing position is less likely to occur, and thus it is possible to increase the accuracy in landing position (edge position). Hence, even when the surface on which the light shielding film is formed is not flat and is irregular, it is possible to increase the accuracy in landing position. As a result, the light shielding film can be formed accurately. Further, since a landing area of each ink liquid droplet is small, it is possible to easily perform fine adjustment of the shape of the light shielding film 17. Since a volume of the ink liquid droplet ejected per a single ejection is small, a thickness of the landed ink can be set to be thin, and an amount of accumulated ink corresponding to the thickness of the light shielding film 17 can be finely adjusted.

The light shielding section 15b of the optical lens 15A has been described. However, also in all the optical lenses 15B, 15D, and 15E included in the lens unit 110, the light shielding section is formed in a way similar to that of the above description. Thereby, it is possible to reliably prevent flares or ghosts from occurring in the entire lens unit 110.

According to the imaging module 100 having the above-mentioned configuration, the light shielding film 17 is formed on the lens surfaces of the optical lenses, and thus it is not necessary to interpose a circular light shielding sheet between the optical lenses. Accordingly, without causing reflection of the incident light reflected by the side surface of the light shielding sheet close to the inner edge thereof, the reflectance of the interface between the optical lens and the light shielding film 17 can be restricted to be lower than the reflectance of the front and back surfaces of the light shielding sheet. As a result, stray light is less likely to occur. Further, it is possible to decrease the height of the lens unit 110, in which the plurality of optical lenses is combined, in the optical axis direction thereof. In addition, it is possible to adopt a configuration advantageous in reducing the height and the size of the entire imaging module.

If the angle of view of the imaging module 100 is increased by a fixed focus optical design, a zoom mechanism, and the like, due to the increase in angle of view, incident light tends to be emitted even further outside than the external edge (the inner edge 23 of the light shielding section 15b) of the lens section 15a. As a result, although there is a concern about an increase in flares and ghosts caused by the internal reflection within the lens, according to the imaging module 100 having the above-mentioned configuration, the light shielding films 17 have reliable light shielding properties since the boundary between the lens section 15a and the light shielding section 15b is reliably subjected to the roughening process. Hence, it is possible to reliably prevent stray light from occurring in the lens and reflected light from reaching other lenses.

The type of the lens is not limited to concave lenses and convex lenses having the above-mentioned disk-like shape, and may be a meniscus lens, a cylindrical lens having a cylindrical lens surface, a ball lens, a rod lens, and the like. By providing the above-mentioned light shielding section in various kinds of lens, it is possible to prevent flares and ghosts from occurring.

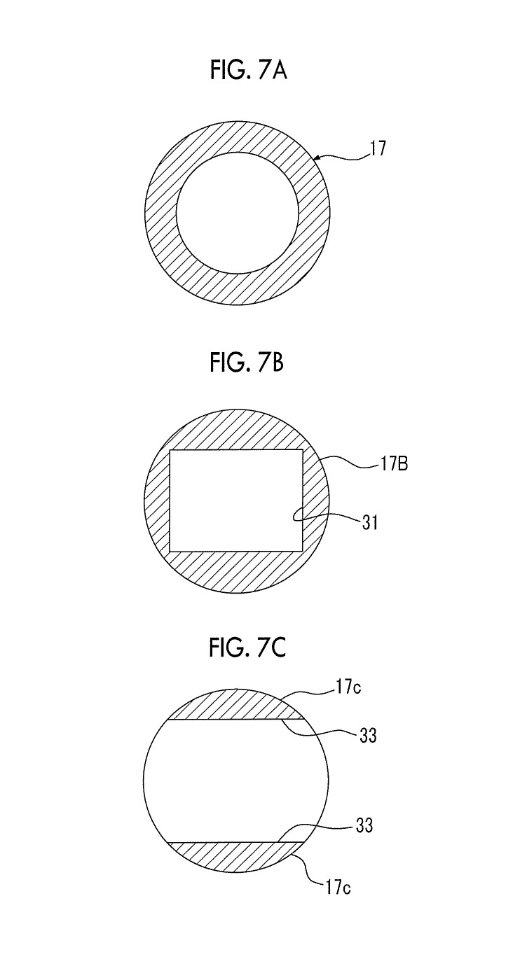

A planar shape of the light shielding film 17 of the light shielding section 15b is circular as shown in FIG. 7A. However, as shown in FIG. 7B, a light shielding film 17B may be formed to have a rectangular aperture 31 of which the inner edge is rectangular. Further, as shown in FIG. 7C, a pair of light shielding films 17C having “D” shapes for restricting an angle of view at the upper and lower ends may be disposed on the optical lens such that the linear portions 33 face each other.

In the above description, a digital camera is exemplified as a device into which the imaging module 100 is built, but there is no limitation to this. Other examples of the devices, into which the imaging module 100 is built, include electronic devices such as built-in or externally-mounted cameras for a personal computer (PC), camera-equipped interphones, on-vehicle cameras, and portable terminal devices having a photography function. Examples of the portable terminal devices include mobile phones, smartphones, personal digital assistants (PDA), portable game machines, and the like.

As described above, the present invention is not limited to the embodiments. It is apparent that the configurations of the embodiments may be combined, or may be modified and applied by those skilled in the art on the basis of description of the specification and the known technology. The combinations, modifications, and applications thereof are within the encompassed scope of the present invention.

Hereinafter, examples thereof will be described.

### Example 1

An ultraviolet curable ink having the following composition was applied onto the substrate in the ink jet method, thereby forming the light shielding film.

<Ink Components>

Monomer: 85%, polymerization initiator: 10%, additives: 3%, diphenyl-2,4,6-trimethylbenzoylphosphine oxide: 1%, carbon black: 1%

The laser blasting process was performed on the light shielding film with laser conditions shown in the following Table 1, thereby roughening the light shielding film surface.

TABLE 1

| | | |
|---|---|---|
| Wavelength | 1060 | nm |
| Pulse period | 100 | kHz |
| Pulse width | 20 | ns |
| Diameter of laser spot | 0.05 | mmφ |
| Beam scanning speed | 2000 | mm/s |
| Energy | 26 | J/mm² |
| Peak power | 2 | kW |

Regarding the light shielding film which is not roughened, assuming that an incident angle of light vertically incident onto the surface is 0°, a gloss level of the light shielding film, which is obtained when light is incident at an incident angle of 60°, was measured. Further, regarding the roughened light shielding film, likewise, the gloss level of the light shielding film, which is obtained when light is incident at the incident angle of 60°, was measured. As a result, before roughening, the gloss level was 51.2%, and after roughening, the gloss level was drastically reduced to 0.5%. Thus, it is possible to sufficiently prevent the surface from reflecting.

### Example 2

An antireflective coat was formed on a surface of a lens made of ZEONEX (registered trademark) grade F52R manufactured by Zeon Corporation. The antireflective coat had a 4-layer structure (thickness of 0.2 μm) in which SiO₂ and ZrO₂ were alternately superimposed, and was formed such that the surface exposed to air was SiO₂. This lens surface was irradiated with laser light under the same conditions as those in Example 1, so that the surface was roughened, and transmittances of the lens before and after roughening were measured. Three lenses were provided, and the measurement was performed on the lenses. Measurement results are shown in Table 2. In Table 2, “ave” indicates an average of three measured values.

TABLE 2

| | n = 1 | n = 2 | n = 3 | ave |
|---|---|---|---|---|
| Before laser | 92.97% | 93.05% | 93.05% | 93.02% |
| process | | | | |
| After laser | 93.19% | 93.31% | 93.30% | 93.27% |
| process | | | | |

As shown in Table 2, it was discovered that the difference in transmittance between before and after the laser process was 0.25%, which was within a measurement error range, and thus deterioration in transmittance of the lens caused by laser irradiation was small enough to be negligible.

From the results of Examples 1 and 2, it was demonstrated that, by making the laser processing range larger than the ink coating range, it is possible to reduce the reflectance in the ink coating range without deterioration in the optical performance (transmittance) of the lens.

As described above, the present specification discloses the following items.

(1) An optical lens including: a lens section that transmits light therethrough; and a light shielding section provided close to the lens section, the light shielding section having a light shielding film formed on a surface of a lens base material, in which a surface layer of at least a part of the light shielding film including an inner edge thereof on a lens section side, and a boundary portion of the lens section in contact with the light shielding layer is subjected to a roughening process

(2) The optical lens according to (1), in which the light shielding film has a thickness that decreases toward to the lens section.

(3) The optical lens according to (1) or (2), in which the light shielding film is formed of a plurality of layers.

(4) A lens unit, in which at least one optical lens according to any one of (1) to (3) is disposed.

(5) An imaging module including: the lens unit according to (4); and an imaging device that detects an image which is formed by the lens unit.

(6) An electronic device, including the imaging module according to (5) mounted therewith.

(7) The electronic device according to (6), in which the electronic device is a digital camera.

(8) The electronic device according to (6), in which the electronic device is an on-vehicle camera.

(9) A method for producing an optical lens including a lens section that transmits light and a light shielding section provided close to the lens section, the method including: forming a light shielding film on at least a part of the light shielding section; and performing a roughening process in a range extending beyond an inner edge of a surface layer of the light shielding film on a lens section side toward an optical axis of the lens section.

(10) The method for producing the optical lens according to (9), in which the roughening process is a laser blasting process.

(11) The method for producing the optical lens according to (9) or (10), in which the light shielding film is formed by an ink jet method using ink which contains a material with a light shielding property.

(12) The method for producing the optical lens according to any one of (9) to (11), in which an amount of the ink ejected per a single ejection is set to be equal to or greater than 0.1 am³ and be equal to or less than 10 fm³.

(13) The method for producing the optical lens according to any one of (9) to (12), in which the light shielding film is formed of a plurality of layers separately formed.

### EXPLANATION OF REFERENCES

11: imaging section
13: lens holder
15A, 15B, 15C, 15D, 15E: optical lenses
15a: lens section
15b: light shielding section
15c: light exit side surface
15d: light incidence side surface
17: light shielding film
19: light shielding layer
21: roughened layer
23: inner edge
27: lens base material
100: imaging module
110: lens unit

What is claimed is:

1. An optical lens comprising:
a lens section that transmits light therethrough; and
a light shielding section provided close to the lens section, the light shielding section having a light shielding film formed on a surface of a lens base material,
wherein a surface layer of at least a part of the light shielding film including an inner edge thereof on a lens section side, and a boundary portion of the lens section in contact with the light shielding layer is subjected to a roughening process.

2. The optical lens according to claim 1, wherein the light shielding film has a thickness that decreases toward the lens section.

3. The optical lens according to claim 1, wherein the light shielding film is formed of a plurality of layers.

4. The optical lens according to claim 2, wherein the light shielding film is formed of a plurality of layers.

5. A lens unit, wherein at least one optical lens according to claim 1 is disposed.

6. A lens unit, wherein at least one optical lens according to claim 2 is disposed.

7. A lens unit, wherein at least one optical lens according to claim 3 is disposed.

8. A lens unit, wherein at least one optical lens according to claim 4 is disposed.

9. An imaging module comprising:
the lens unit according to claim 5; and
an imaging device that detects an image which is formed by the lens unit.

10. An electronic device, comprising the imaging module according to claim 9 mounted therewith.

11. The electronic device according to claim 10, wherein the electronic device is a digital camera.

12. The electronic device according to claim 10, wherein the electronic device is an on-vehicle camera.

13. A method for producing an optical lens including a lens section that transmits light therethrough and a light shielding section provided close to the lens section, the method comprising:
forming a light shielding film on at least a part of the light shielding section; and
performing a roughening process in a range extending beyond an inner edge of a surface layer of the light shielding film on a lens section side toward an optical axis of the lens section.

14. The method for producing the optical lens according to claim 13, wherein the roughening process is a laser blasting process.

15. The method for producing the optical lens according to claim 13, wherein the light shielding film is formed by an ink jet method using ink which contains a material with a light shielding property.

16. The method for producing the optical lens according to claim 14, wherein the light shielding film is formed by an ink jet method using ink which contains a material with a light shielding property.

17. The method for producing the optical lens according to claim 15, wherein an amount of the ink ejected per a single ejection is set to be equal to or greater than 0.1 am³ and be equal to or less than 10 fm³.

18. The method for producing the optical lens according to claim 16, wherein an amount of the ink ejected per a single ejection is set to be equal to or greater than 0.1 am³ and be equal to or less than 10 fm³.

19. The method for producing the optical lens according to claim 13, wherein the light shielding film is formed of a plurality of layers separately formed.

20. The method for producing the optical lens according to claim 14, wherein the light shielding film is formed of a plurality of layers separately formed.
